(19) United States
(12) Patent Application Publication
(10) Pub. No.: US 2024/0377106 A1
(43) Pub. Date: Nov. 14, 2024

(54) Method for Providing Process Steam and Industrial Plant for Utilizing Process Steam

(71) Applicant: Fraunhofer-Gesellschaft zur Förderung der angewandten Forschung e.V., München (DE)

(72) Inventors: Marcus Budt, Essen (DE); Sven Klute, Bochum (DE)

(21) Appl. No.: 18/289,652

(22) PCT Filed: Apr. 13, 2022
(86) PCT No.: PCT/EP2022/059937

§ 371 Date: Nov. 6, 2023

(30) Foreign Application Priority Data
May 7, 2021 (DE) 10 2021 111 918.9

(51) Int. Cl. F24T 10/10

(52) U.S. Cl. CPC F24T 10/10

(57) ABSTRACT

Described and illustrated is a method for providing process steam for a process, in particular a process engineering process, using geothermal heat. In order to enable a more climate-friendly, simpler, more efficient and more economical operation, it is provided that the geothermal heat of a thermal fluid heated in a geothermal heat source is used to provide a geothermal steam, that an upgrading steam is used to upgrade the geothermal steam and that during the upgrading the geothermal steam is simultaneously compressed and heated.

### CROSS-REFERENCE TO RELATED APPLICATIONS

This application is the United States national phase of International Application No. PCT/EP2022/059937 filed Apr. 13, 2022, and claims priority to German Patent Application No. 10 2021 111 918.9 filed May 7, 2021, the disclosures of which are hereby incorporated by reference in their entireties.

### BACKGROUND OF THE INVENTION

### Field of the Invention

The invention relates to a method for providing process steam for a process, in particular a process engineering process, using geothermal heat. Furthermore, the invention relates to a process engineering plant, in particular for paper production, for the use of process steam provided using geothermal heat.

Geothermal heat refers to the energy present in the form of heat below the earth's surface. If a geothermal heat source is used at a depth of up to 400 m below the earth's surface, it is referred to as near-surface geothermal energy, while at even greater depths it is referred to as deep geothermal energy. The potential use of deep geothermal energy is divided into hydrothermal systems, in which warm, naturally occurring underground water is used, and petrothermal systems, in which mainly the energy stored in the rock is used, for example by deep geothermal probes or water pumped into the rock. In many cases, the temperature level of the usable geothermal heat is so low that it is used only for heating and cooling buildings. At some sites, however, the temperature is so high that process steam can be extracted from the geothermal heat for use in process engineering plants.

### Description of Related Art

In this context, methods are known in which water is converted into process steam in an evaporator via indirect heat exchange using thermal water, which process steam can then be used in a process engineering plant. However, this requires the availability of thermal water at a temperature level above the temperature level of the process steam. However, since the temperatures of the thermal water are often not sufficient for this purpose, various methods have been proposed for providing process steam at a higher temperature level than the temperature level of the thermal water. For example, it is known to expand the thermal water in a flash tank to produce steam, heating either the thermal water or the steam by combusting fossil fuels to provide process steam at the desired temperature level. Alternatively, the steam generated in the flash tank can be heated to the required process steam temperature or brought to the required process steam pressure via mechanical compression. In a further variation of the method, the steam from the flash tank is first used to evaporate a process fluid, wherein the temperature of the steam of the process fluid is then raised by means of mechanical compression to obtain process steam of the desired temperature level or pressure level. The raising of the pressure is accompanied by a temperature increase, wherein the temperature can be specifically adjusted or varied in a further process step. Furthermore, the use of closed heat pumps is also known in this context. However, these methods are severely limited in terms of the temperatures of the thermal water and the temperatures that can be achieved due to the heat pump media required. With known methods using closed heat pumps, temperatures of a maximum of 160° C. can be achieved. There is therefore a further need for simpler, more efficient and more economical methods and process engineering plants.

### SUMMARY OF THE INVENTION

Therefore, the present invention is based on the object of designing and further developing the method and the process engineering plant, in each case of the type mentioned at the beginning and explained in more detail above, in such a way that a more climate-friendly, simpler, more efficient and more economical operation is possible.

This object is solved as described herein by a method for providing process steam for a process, in particular a process engineering process, using geothermal heat,
in which the geothermal heat of a thermal fluid heated in a geothermal heat source is used to provide a geothermal steam,
in which an upgrading steam is used to upgrade the geothermal steam, and
in which the geothermal steam is simultaneously compressed and heated during upgrading.

The said task is further solved as described herein by a process engineering plant, in particular for paper production, for the use of process steam using geothermal heat, in particular as described herein, comprising a geothermal station for heating a thermal fluid by geothermal heat in an underground geothermal heat source and for providing a geothermal steam using the geothermal heat of the thermal fluid, a source of upgrading steam and an upgrading device for simultaneously compressing and upgrading the geothermal steam by the upgrading steam.

Thus, according to the invention, the process steam is generated by using a geothermal steam and an upgrading steam. The geothermal steam is generated using a geothermal heat source. For this purpose, a heated thermal fluid, which is preferably water, is extracted from the ground and used to generate a geothermal steam. In the process, the thermal fluid can be expanded in a flash tank, for example, and in particular when the thermal fluid is in liquid form. The steam exiting from the flash tank can then be used directly as geothermal steam or heated further. In particular, in the case where the thermal fluid is initially present as a liquid-steam mixture, the thermal fluid can be separated in a flash tank into steam and liquid. If the thermal fluid is also partially expanded, part of the liquid phase in the flash tank can also be evaporated.

It is also conceivable that the thermal fluid initially transfers some of its heat to another fluid in order to evaporate or at least heat it. This is particularly useful for providing a thermal circuit, for example if undesirable impurities of the thermal fluid are to be expected in the geothermal heat source. Then the heat of the thermal fluid can first be transferred to water or another medium that is easy to handle. The heated water or other medium can be separated into steam and liquid in a flash tank and/or partially expanded to form steam. The steam can be used directly as geothermal steam or further heated in a separate step beforehand.

If the thermal fluid in the geothermal heat source is heated to a temperature of less than 100° C., the thermal fluid can then be heated further using another heat source to generate a geothermal steam with the correspondingly heated thermal fluid. If necessary, the heat of the thermal fluid can also first be transferred to water or another medium, which is then further heated in a further step to generate geothermal steam in this way.

In particular, if thermal fluid is only available at a low temperature level, geothermal steam can be used or provided at a pressure below ambient or normal pressure. This is, if necessary, associated with energy advantages, as only a low enthalpy of vaporization is required. Accordingly, the temperature of the geothermal steam can be much lower than the 100° C. required under normal conditions. Through the subsequent upgrading, process steam can then still be obtained without any problems at a pressure which can be significantly higher than the ambient pressure or the normal pressure. In other words, the pressure level of the geothermal steam is not necessarily limited downward by the ambient pressure or the normal pressure. Rather, the pressure of the geothermal steam can be selected in a suitable manner depending on the application.

The upgrading steam can be obtained in a different way than by using the geothermal heat or can be available anyway. In this way, the upgrading steam can energetically upgrade the geothermal steam by means of upgrading. In the present context, an upgrading is to be understood as a method step in which the geothermal steam is heated and compressed simultaneously. Heating and compressing cannot be divided into two separate and disconnected from each other method steps. In principle, this could therefore also be referred to as thermal compression.

The process described above can be used in a process engineering plant to provide process steam. For this purpose, a geothermal station is required to heat the thermal fluid by means of an underground geothermal heat source. In addition, in the geothermal station geothermal steam is generated using the geothermal heat from the thermal fluid. Furthermore, a source for upgrading steam is required, wherein the upgrading steam can already be available if necessary, i.e. it does not have to be generated separately. The upgrading steam is used in an upgrading device to upgrade the geothermal steam by simultaneously compressing and heating the geothermal steam by the upgrading steam.

Here it is particularly suitable if the process engineering plant is a paper production plant. Here, the advantages of the method are particularly effective, since in paper production quite a lot of process steam is required at an at least moderate to high temperature and pressure level. This can be ensured in a particularly climate-friendly, simple, efficient and economical manner in the way described.

In a first particularly preferred embodiment of the method, an upgrading steam with a higher pressure and higher temperature than the pressure and temperature of the geothermal steam is used to upgrade the geothermal steam. This is particularly easy to do. It is possible, for example, to mix the upgrading steam and the geothermal steam by means of equipment and process engineering during upgrading. However, this is not necessary. It would also be possible to compress and heat the geothermal steam simultaneously during upgrading without mixing the upgrading steam and geothermal steam. A particularly simple example of this would be indirect heat transfer. In addition, it is conceivable that the geothermal steam is upgraded with an upgrading steam with a lower pressure and lower temperature than the geothermal steam. In principle, however, this would require an increased expenditure on equipment.

For the sake of simplicity, it is convenient if the geothermal steam is heated and compressed by the upgrading steam in a steam jet compressor by means of direct heat exchange. In this process, the upgrading steam is partially expanded via a throttle of the steam jet compressor so that the upgrading steam reaches a high velocity and thereby draws geothermal steam from a secondary line at a lower pressure than the initial pressure of the upgrading steam. The geothermal steam is then mixed with the upgrading steam and accelerated in the process. Subsequently, the generated mixed steam of geothermal steam and upgrading steam is decelerated in a diffuser, thus generating a process steam with a sufficient pressure and sufficient temperature. The pressure of the process steam and its temperature ranges preferably between the pressure and temperature of the upgrading steam and the geothermal steam.

Alternatively or additionally, the geothermal steam can be heated and compressed by the upgrading steam using a compressor comprising a turbine driven by the upgrading steam. This basically allows for greater flexibility in terms of the amount and type of upgrading of the geothermal steam. Here, mixing of upgrading steam and geothermal steam can be omitted if necessary. The upgrading steam drives a turbine separately from the geothermal steam, which turbine then drives a compressor in which the geothermal steam is upgraded at least in one stage. This upgrading takes place with simultaneous compressing and heating of the geothermal steam.

It is particularly suitable if a turbo-compressor of a turbocharger driven by the turbine is used as the compressor. In such a turbocharger, the turbine and the turbo-compressor can be arranged on a common shaft so that the turbine and the turbo-compressor are directly coupled without a speed-up ratio if necessary. However, this is not mandatory. Any type of transmission could also be provided between the turbine and the turbo-compressor to provide a speed-up ratio or optionally a reduction ratio between the turbine and the turbo-compressor. In this case, the turbine can be operated with available upgrading steam, wherein it is not so crucial for the upgrading of the geothermal steam which process parameters the upgrading steam has. In principle, the available mass flow of the upgrading steam is of greater importance here. Consequently, the upgrading steam in this case can also easily have a temperature and pressure that are lower than the temperature and pressure of the geothermal steam. The design of the turbocharger allows for expedient upgrading of the geothermal steam in terms of pressure and temperature in the turbo-compressor of the turbocharger. The turbo-compressor is driven by the upgrading steam and the turbine, wherein the turbine and the turbo-compressor are being coupled via a shaft and if required a transmission. In the turbo-compressor, the geothermal steam is compressed and also heated by the heat generated in the process.

The upgrading steam does not necessarily have to be completely expanded when it passes through the turbine. If the upgrading steam is only partially expanded in the turbine, it can be useful to increase efficiency if the partially expanded upgrading steam is mixed with the geothermal steam after it exits the turbine, in particular if it is used to drive a steam jet compressor. This is of particular interest if the steam jet compressor is used to further heat and compress the geothermal steam after it exits the compressor. In this case, the compressor can preferably be a turbo-compressor of a turbocharger. However, this is not mandatory.

It may also be provided that the upgrading steam is expanded in a turbine, such as of a turbocharger, to such an extent that the upgrading steam after exiting the turbine is at least substantially at a pressure level corresponding to the geothermal steam compressed in the turbo-compressor. Then the partially expanded upgrading steam and the compressed geothermal steam can be mixed to make efficient use of the upgrading steam produced. A steam jet compressor is then not required. A simple mixing chamber is sufficient for this purpose. In addition, the temperature levels of the compressed geothermal steam and the partially expanded upgrading steam can also at least substantially correspond to each other. However, this is not necessary. It would regularly be advantageous if the upgrading steam would be significantly warmer than the compressed geothermal steam before mixing with it. Then not only the pressure of the upgrading steam but also its temperature would be used particularly expediently. However, mixing of partially expanded upgrading steam and compressed geothermal steam would also be possible if the upgrading steam would be at a lower temperature than the compressed geothermal steam before mixing. In any case, the compressed geothermal steam exiting the turbo-compressor and the upgrading steam exiting the turbine can be mixed to form the process steam. This allows the partially expanded upgrading steam to be used to operate the subsequent process, in particular process engineering process.

The thermal fluid may be contaminated, for example, by the underground heating in the geothermal heat source with respective impurities. In this case, it may be useful if the thermal fluid first transfers the geothermal heat via an indirect heat exchange to water or another medium, which then takes over the further transport of the geothermal heat in the direction of the process engineering process. In such a case, it may be further appropriate if the thermal fluid is not water but some other heat transfer medium. The thermal fluid then does not have to be evaporated to produce, for example, water steam, so that no consideration has to be given to this when selecting the thermal fluid. Nevertheless, for the sake of simplicity, it may also be appropriate to use water as the thermal fluid.

Regardless of the choice of thermal fluid, it is particularly simple and reliable if water is at least partially evaporated by the indirect heat exchange with the thermal fluid to form geothermal steam. If the water is only partially evaporated to form geothermal steam, it may be convenient if the geothermal steam and the unevaporated water are directed to a flash tank to separate the geothermal steam and the water. If the pressure in the flash tank is still significantly expanded, at least part of the water can be evaporated to geothermal steam. The correspondingly recovered water steam can then be used as geothermal steam for upgrading by the upgrading steam with a simultaneous increase in pressure and temperature.

For economic reasons, the upgrading steam can be obtained by combusting fossil fuels, for example in a boiler. However, to increase the overall efficiency and from an ecological point of view, it may also be preferable if biomass, biogas and/or residual materials are used as at least partial substitutes for fossil fuels to generate the upgrading steam, wherein the residual materials may also be biomass if required. This is the case in particular if the biomass, the biogas and/or the residual materials are produced and/or generated in the process engineering plant to be heated, in particular in the process, in particular process engineering process, for which the process steam is provided. However, the combustion of fossil fuels, biomass, biogas or residual materials can also be dispensed with entirely for the generation of the upgrading steam. Biogas can also be understood here as synthetically, in particular regeneratively, produced hydrogen and methane. Corresponding alternative methods are known to the person skilled in the art and are adequately described in the state of the art.

The method can be used particularly efficiently if the heated thermal fluid with a temperature of at least 60° C., at least 80° C., in particular at least 100° C., is used to provide a geothermal steam. Then only a moderate upgrading of the geothermal steam is required. Furthermore, it may alternatively or additionally help to increase efficiency if the heated thermal fluid with a temperature of at most 220° C., preferably at most 180° C., in particular at most 140° C., is used to provide a geothermal steam. Otherwise, in most cases only a minor upgrading is required, which can only partially justify the process engineering and equipment costs.

For the same reasons, it may be alternatively or additionally preferred if the geothermal steam is not too cold and/or not too hot before upgrading using the upgrading steam. In this case, high efficiency is achieved if the geothermal steam has a temperature of at least 60° C., at least 80° C., in particular at least 100° C., before upgrading. However, it can also be provided that the geothermal steam has a temperature of at most 220° C., preferably at most 180° C., in particular at most 140° C., before upgrading.

The heat of the thermal fluid can be used easily and efficiently if the geothermal steam is heated by at least 20° C., preferably at least 50° C., in particular at least 100° C., during the upgrading. However, the same also applies alternatively or additionally in the event that the geothermal steam is compressed by at least 1 bar, preferably at least 2 bar, in particular at least 3 bar, during the upgrading.

In a first particularly preferred embodiment of the process engineering plant, the source for upgrading steam is such a source which is designed to provide upgrading steam at a higher pressure and higher temperature than the pressure and temperature of the geothermal steam. In such a case, the upgrading of the geothermal steam can be carried out simply in terms of equipment and process engineering, for example by mixing the upgrading steam with the geothermal steam.

Especially in such a case, the upgrading device preferably comprises a steam jet compressor in order to provide a process steam with a temperature and a pressure above the initial pressure of the geothermal steam by appropriately combining the geothermal steam and the upgrading steam in the steam jet compressor. This is easy to implement and efficient to perform. However, it is not mandatory in the aforementioned case or in any case other than the aforementioned case.

Alternatively or additionally, the upgrading device comprises a compressor having a turbine driven by the upgrading steam for heating up and compressing the geothermal steam. This can be done particularly easily and at the same time economically if the compressor is a thermocompressor of a turbocharger. The upgrading steam can then drive a turbine of the turbocharger, which drives the thermocompressor of the turbocharger to compress the geothermal steam. When the geothermal steam is compressed in the thermocompressor, so much heat is generated that the geothermal steam is also heated at the same time as it is compressed.

For further energy optimization, a connecting line can be provided for feeding the partially expanded upgrading steam exiting the turbine into a steam jet compressor. In this case, the steam jet compressor serves to further heat and compress the geothermal steam already partially heated and compressed in the turbo-compressor. Although the use of a steam jet compressor for mixing partially expanded upgrading steam and partially compressed geothermal steam is preferred here, this mixing could also take place in another mixing chamber than a steam jet compressor.

In order to avoid unnecessary contamination by the thermal fluid and also to keep maintenance costs low, it may be advisable to route the thermal fluid in a thermal circuit. The thermal circuit has an indirect heat exchanger to transfer the heat of the thermal fluid to water or another medium.

If the thermal fluid is hotter than 100° C. and also at least partially liquid, the thermal fluid can be fed into a flash tank for steam generation. If the thermal fluid is water, water can be added to the portion of the thermal fluid that is not evaporated in the process before the thermal fluid is again used for underground heating by geothermal heat. However, it is also possible to first transfer the geothermal heat from the thermal fluid of the thermal circuit to water in an indirectly heated evaporator in order to evaporate the water in the evaporator. In principle, it does not matter whether water is already used as the thermal fluid. Moreover, from the point of view of energy and design, it is generally advisable if the aforementioned heat exchanger of the thermal circuit forms part of the evaporator for at least partial evaporation of the water and provision of the geothermal steam.

For the simple and economical generation of upgrading steam and/or geothermal steam, an evaporator fired with fossil fuels, biogas and/or biomass can be used if upgrading steam is not available anyway. In principle, however, all other processes and plants for steam generation or for the provision of upgrading steam and/or geothermal steam are also conceivable.

### BRIEF DESCRIPTION OF THE INVENTION

The invention is explained in more detail below by means of a drawing showing only examples of embodiments. The drawing shows

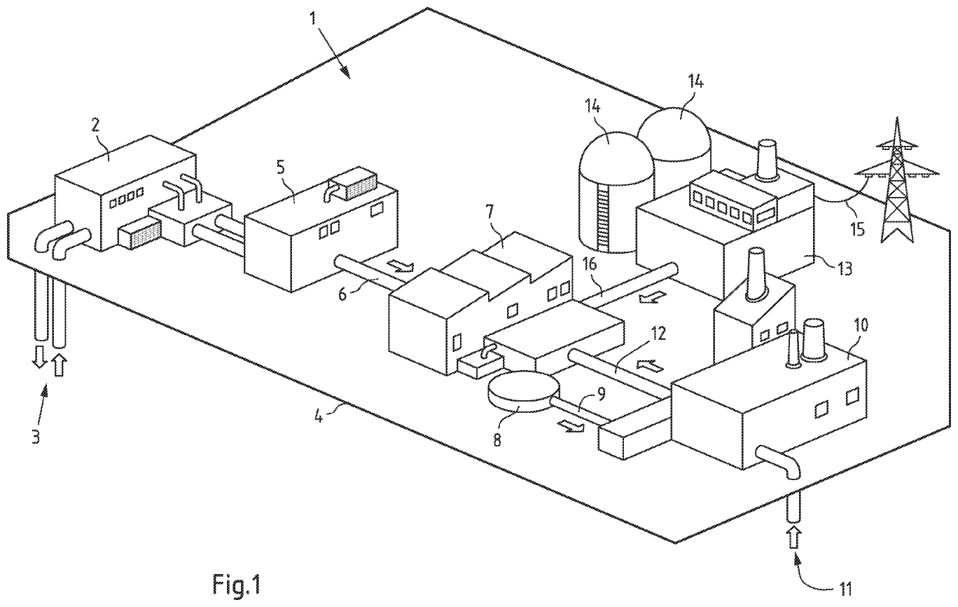

FIG. 1 a process engineering plant according to the invention for the use of geothermal heat in a schematic representation,

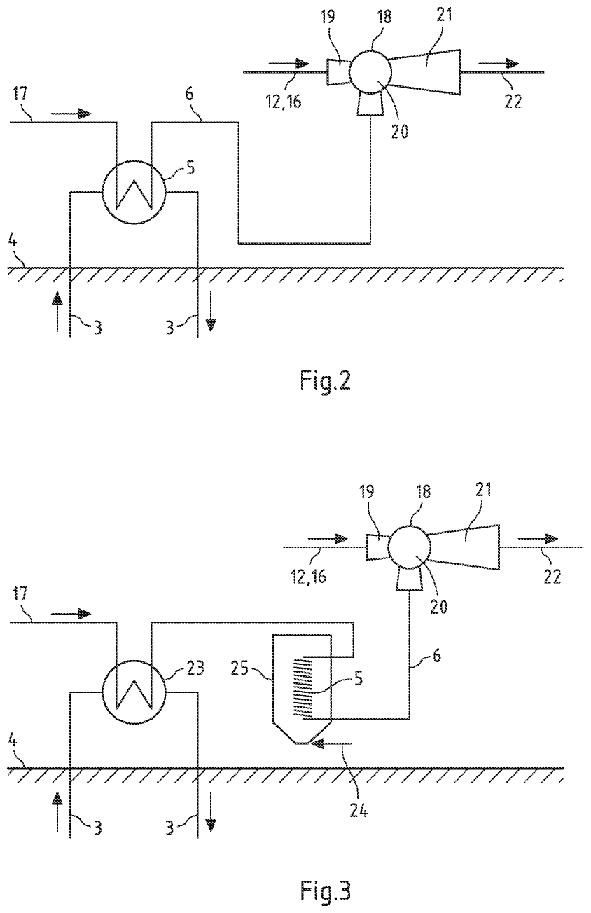

FIG. 2 a first method according to the invention for the use of geothermal heat in a schematic representation,

FIG. 3 a second method according to the invention for the use of geothermal heat in a schematic representation and

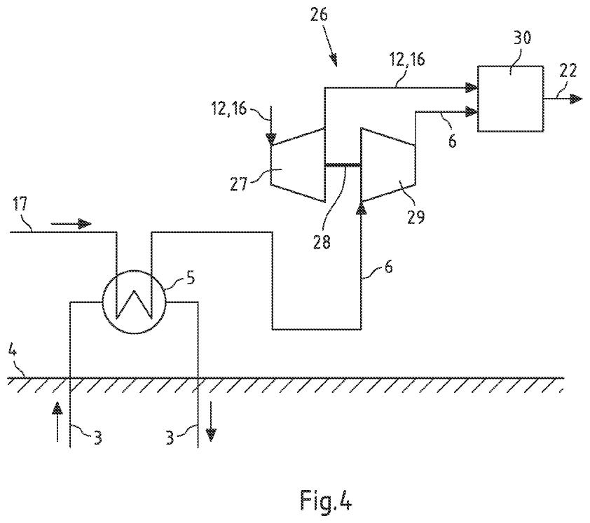

FIG. 4 a third method according to the invention for the use of geothermal heat in a schematic representation.

### DESCRIPTION OF THE INVENTION

In FIG. 1, a process engineering plant 1 for paper production is shown, wherein a process steam is used in this process engineering plant 1, which process steam has been generated using geothermal heat. To use the geothermal heat, a geothermal station 2 is provided in which a thermal fluid 3, which for simplicity can be water, is pumped into the ground to heat the thermal fluid 3 there by means of a geothermal heat source. The thermal fluid 3 heated in this way is transported back to the earth's surface 4 and there delivered to an evaporator 5, in which a geothermal steam 6 is generated from the thermal fluid 3, which geothermal steam is then delivered to the paper fabrication 7. During paper production in the paper fabrication 7, wastewater is produced, which is treated in a wastewater treatment unit 8 while producing biogas 9. For the generation of biogas 9, biomass produced elsewhere in the overall process could also be used if required. The biogas 9 is delivered to a combined heat and power plant 10 where it is combusted together with natural gas 11 to form upgrading steam 12. Furthermore, a biomass power generation plant 13 is also provided, which generates electricity 15 from biomass 14 on the one hand, but also upgrading steam 16 on the other. If necessary, the biomass power generation plant 13 or the combined heat and power plant 10 could also be dispensed with. However, an entirely different source of upgrading steam 12,16 could also be used. However, regardless of how it is produced, the upgrading steam 12,16 has a pressure that is higher than the pressure of the geothermal steam 6. In addition, the temperature of the upgrading steam 12,16 is higher than the temperature of the geothermal steam 6.

In the paper fabrication 7, a process steam is generated from the upgrading steam 12,16 and the geothermal steam 6, which is then used for paper production, in particular for heating certain processes in paper production. Various methods are possible for this purpose, of which only three different methods are shown by way of example in FIGS. 2 to 4 and are described below.

FIG. 2 shows a method in which a thermal fluid 3 is heated to a temperature higher than 100° C. in an underground geothermal heat source, which is not shown. After the heated thermal fluid 3 is transported back to the earth's surface 4, the heat of the thermal fluid 3 is used in an evaporator 5 to evaporate water 17, which is then delivered as geothermal steam 6 to a steam jet compressor 18. The steam jet compressor 18 is operated with the upgrading steam 12,16 which is accelerated in the steam jet compressor 18 by partial expansion via a throttle 19, so that after the throttle 19 the geothermal steam 6 is sucked into a mixing chamber 20 where it is mixed with the upgrading steam 12,16. The steam is then guided via a diffuser 21 and thus decelerated again, so that a process steam 22 is produced with a pressure and temperature that are each higher than the pressure and temperature of the geothermal steam 6. Consequently, the geothermal steam 6 has been upgraded in terms of pressure and temperature by the use of the upgrading steam 12,16 and can then be efficiently used as process steam 22 in the paper fabrication 7 for paper production.

As an alternative to the method shown in FIG. 2, the thermal fluid could, for example, be expanded in a flash tank and the resulting steam could be delivered to the steam jet compressor as geothermal steam. A prior transfer of the geothermal heat from the thermal fluid to the water could then be omitted.

FIG. 3 shows a method in which a thermal fluid 3 is heated to a temperature of less than 100° C. in an underground geothermal heat source, which is not shown. After the heated thermal fluid 3 is transported back to the earth's surface 4, an indirect heat exchange with water 17 occurs in a heat exchanger 23 to transfer the geothermal heat to the water 17 in this way. The water 17 is then evaporated in an evaporator 5 of a boiler 25 fired with a fossil and/or renewable fuel 24. However, an evaporator 5 operated in a different manner would also be conceivable. The geothermal steam 6 exits the evaporator 5 in the illustrated and in this respect preferred embodiment example, which geothermal steam is fed to a steam jet compressor 18 and is upgraded there as described above by means of an upgrading steam 12,16 driving the steam jet compressor 18 by simultaneous temperature and pressure increase.

Also as an alternative to the method shown in FIG. 3, the thermal fluid 3 could, for example, be expanded in a flash tank and the steam produced in the process could be delivered to the steam jet compressor 18 as geothermal steam 6. A prior transfer of geothermal heat from the thermal fluid 3 to the water 17 could then be omitted. However, it could also be envisaged to evaporate the thermal fluid 3 in an evaporator 5 by applying additional heat. The resulting steam could then be delivered directly to the steam jet compressor 18 as geothermal steam 6 or used to evaporate water 17. In the latter case, the water steam so formed is delivered as geothermal steam 6 to steam jet compressor 18.

FIG. 4 shows a method in which a thermal fluid 3 is heated to a temperature of higher than 100° C. in an underground geothermal heat source, which is not shown. After the heated thermal fluid 3 has been transported back to the earth's surface 4, the heat of the thermal fluid 3 is used in an evaporator 5 to evaporate water 17, which is then delivered as geothermal steam 6 to a turbocharger 26. The thermal fluid does not necessarily have to be circulated. The thermal fluid can also be withdrawn from the ground at one point and re-injected into the ground at another point. In particular, if the thermal fluid flows through the ground as naturally occurring underground water, the same thermal fluid is not always used, but rather different thermal fluid from the same source is always used as needed.

The turbocharger 26 has a turbine 27 which is connected to a turbo-compressor 29 via a shaft 28. The turbine 27 is loaded with upgrading steam 12,16, which is partially expanded in the turbine 27 and drives the shaft 28. The shaft 28 then drives the turbo-compressor 29, which compresses the geothermal steam 6 and simultaneously heats it. Subsequently, in the illustrated and in this respect preferred embodiment example, the compressed geothermal steam 6 is mixed with the partially expanded upgrading steam 12,16 in a mixing chamber 30 in order to provide further upgrading with simultaneous increase in pressure and temperature in addition to the upgrading of the geothermal steam 6 with simultaneous increase in pressure and temperature in the turbocharger 26. For this purpose, the turbine 27 is connected to the mixing chamber 30 via a connecting line 31. Preferably, the mixing chamber 30 may be a mixing chamber of a steam jet compressor. Subsequent mixing of compressed geothermal steam 6 and partially expanded upgrading steam 12,16 to form the process steam 22 may be particularly useful if the upgrading steam 12,16 has a much higher pressure than the geothermal steam 6. This is because the upgrading steam 12,16 preferably still has a pressure after partial expansion in the turbine 27 of the turbocharger 26 that is higher than the pressure of the compressed geothermal steam 6 after exiting the turbo-compressor 29. However, this is not necessarily the case.

Alternatively, it may also be provided that the upgrading steam 12,16 is expanded in the turbine 27 of the turbocharger 26 just to such an extent that the thus partially expanded upgrading steam 12,16 after exiting the turbine 27 has a pressure level which at least substantially corresponds to the pressure level of the compressed geothermal steam 6 exiting the turbo-compressor 29. Then the partially expanded upgrading steam 12,16 and the geothermal steam 6 can be mixed without a steam jet compressor, if necessary in a very simple mixing chamber 30. The partially expanded upgrading steam 12,16 and the upgraded geothermal steam 6 can then be used together in the subsequent process, in particular process engineering process, as process steam 22.

Also as an alternative to the method shown in FIG. 4, the thermal fluid 3 could, for example, be expanded in a flash tank and the steam produced in the process could be delivered as geothermal steam 6 to the turbo-compressor 29 of the turbocharger 26. A prior transfer of the geothermal heat from the thermal fluid 3 to the water 17 could then be omitted.

### LIST OF REFERENCE SIGNS

1 Process engineering plant
2 Geothermal station
3 Thermal fluid
4 Earth surface
5 Evaporator
6 Geothermal steam
7 Paper fabrication
8 Water treatment unit
9 Biogas
10 Combined heat and power plant
11 Natural gas
12 Upgrading steam
13 Biomass power generation plant
14 Biomass
15 Electricity
16 Upgrading steam
17 Water
18 Mixing chamber
19 Throttle
20 Mixing chamber
21 Diffuser
22 Process steam
23 Heat exchanger
24 Fuel
25 Boiler
26 Turbocharger
27 Turbine
28 Shaft
29 Turbo-compressor
30 Mixing chamber
31 Connecting line

1. A method for providing process steam for a process, in particular a process engineering process, using geothermal heat, in which the geothermal heat of a thermal fluid heated in a geothermal heat source is used to provide a geothermal steam, in which an upgrading steam is used to upgrade the geothermal steam, and in which the geothermal steam is simultaneously compressed and heated in a compressor during the upgrading.

2. The method according to claim 1, wherein the upgrading steam with a higher pressure and higher temperature than the pressure and temperature of the geothermal steam is used to upgrade the geothermal steam and/or wherein the upgrading steam and the geothermal steam are mixed during upgrading.

3. The method according to claim 1, in which the geothermal steam is heated and compressed by the upgrading steam in a steam jet compressor by means of direct heat exchange and/or by means of a compressor comprising a turbine driven by the upgrading steam and in which, preferably, a turbo-compressor of a turbocharger driven by the turbine is used as compressor.

4. The method according to claim 3, wherein the partially expanded upgrading steam after exiting the turbine is used to drive a steam jet compressor to further heat and compress the geothermal steam after exiting the compressor.

5. The method according to claim 3, wherein the partially expanded upgrading steam after exiting the turbine and the upgraded geothermal steam after exiting the turbo-compressor are mixed in a mixing chamber and wherein, preferably, the partially expanded upgrading steam and the upgraded geothermal steam have at least substantially the same pressure before mixing in the mixing chamber.

6. The method according to claim 1, wherein the thermal fluid delivers geothermal heat to water via indirect heat exchange and wherein, preferably, the water is at least partially evaporated by the indirect heat exchange with the thermal fluid to form geothermal steam.

7. The method according to claim 6, wherein the thermal fluid or the water heated and/or partially evaporated by the geothermal heat is evaporated in an evaporator, in particular completely, to form geothermal steam.

8. The method according to claim 1, wherein the upgrading steam is generated by combustion of fossil fuels, biogas, biomass, and/or residual materials.

9. The method according to claim 1, in which the heated thermal fluid with a temperature of at least 60° C., at least 80° C., in particular at least 100° C., and/or of at most 220° C., preferably at most 180° C., in particular at most 140° C., is used to provide a geothermal steam and/or in which the geothermal steam has a temperature of at least 60° C., at least 80° C., in particular at least 100° C., and/or of at most 220° C., preferably at most 180° C., in particular at most 140° C., before upgrading.

10. The method according to claim 1, in which the geothermal steam is heated by at least 20° C., preferably at least 50° C., in particular at least 100° C., during the upgrading and/or in which the geothermal steam is compressed by at least 1 bar, preferably at least 2 bar, in particular at least 3 bar, during the upgrading.

11. A process engineering plant, in particular for paper production, for the use of process steam, provided using geothermal heat according to claim 1, comprising a geothermal station for heating a thermal fluid by geothermal heat in an underground geothermal heat source and for providing a geothermal steam using the geothermal heat of the thermal fluid, a source of upgrading steam and an upgrading device for simultaneously compressing and heating the geothermal steam by the upgrading steam.

12. The process engineering plant according to claim 9, wherein in that the source for the upgrading steam is a source for providing upgrading steam with a higher pressure and higher temperature than the pressure and temperature of the geothermal steam and/or in that the upgrading device comprises a steam jet compressor and/or a compressor comprising a turbine driven by the upgrading steam for heating and compressing the geothermal steam and, preferably, that the compressor is a turbo-compressor of a turbocharger driven by the turbine.

13. The process engineering plant according to claim 10, wherein a connecting line is provided for feeding the partially expanded upgrading steam exiting the turbine into a steam jet compressor for further heating and compressing the geothermal steam heated and compressed in the turbo-compressor.

14. The process engineering plant according to claim 10, wherein a thermal circuit comprising the thermal fluid and an indirect heat exchanger is provided for transferring geothermal heat to water and/or that an evaporator is provided for providing the geothermal steam, in particular from the water heated by means of geothermal heat.

15. The process engineering plant according to claim 12, wherein the heat exchanger is part of the evaporator for at least partially evaporating the water and providing the geothermal steam.

16. The process engineering plant according to claim 9, wherein an evaporator fired with fossil fuels and/or biomass is provided for providing the geothermal steam and/or the upgrading steam.
